(19) United States
(12) Patent Application Publication
(10) Pub. No.: US 2016/0104094 A1
(43) Pub. Date: Apr. 14, 2016

(54) FUTURE MEETING EVALUATION USING IMPLICIT DEVICE FEEDBACK

(71) Applicant: Microsoft Corporation, Redmond, WA (US)

(72) Inventors: Elad Yom-Tov, Hoshaya (IL); Mariano R. Schain, Ramat-Hasharon (IL); Moshe Tennenholtz, Haifa (IL)

(73) Assignee: Microsoft Corporation, Redmond, WA (US)

(21) Appl. No.: 14/510,891

(22) Filed: Oct. 9, 2014

(51) Int. Cl. G06Q 10/06; G06Q 10/10

(52) U.S. Cl. CPC G06Q 10/06395; G06Q 10/109

(57) ABSTRACT

This document relates to meeting evaluation. One example determines previous meeting attributes of previous meetings that were attended by a user or to which the user was invited, and obtains implicit feedback about the previous meetings from a device of the user. The example includes training a predictive algorithm to evaluate future meetings for the user using the previous meeting attributes and the implicit feedback about the previous meetings.

### BACKGROUND

People within organizations may spend a significant amount of time attending both physical and virtual meetings. Typically, a user determines whether or not to attend a particular meeting based on their own previous experiences and judgment as to the value of the meeting. However, sometimes people decide to attend meetings that they ultimately decide they should not have attended. This is partly because people often do not have adequate decision-making tools to enable them to accurately ascertain the likely value of a given future meeting.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to automated techniques for evaluating the expected effectiveness of future meetings. One example includes a method or technique that can be performed by at least one hardware processor. The method or technique can include determining previous meeting attributes of previous meetings that were attended by a user or to which the user was invited, and obtaining implicit feedback about the previous meetings from a device of the user. The method or technique can also include training a predictive algorithm to evaluate future meetings for the user using the previous meeting attributes and the implicit feedback about the previous meetings.

Another example includes another method or technique that can be performed by at least one hardware processor. This method or technique can include obtaining explicit evaluations of certain previous meetings attended by a user and obtaining implicit feedback about the certain previous meetings from a device of the user. The method can also include training a mapping algorithm to map the implicit feedback to the explicit evaluations.

Another example includes a computing system that includes one or more hardware processing units and one or more computer-readable storage devices. The computer-readable storage devices can store computer-executable instructions which, when executed by the one or more hardware processing units, can cause the one or more hardware processing units to monitor usage of the computing device during certain meetings to obtain implicit feedback about the certain meetings. The computer-readable storage devices can also cause the one or more hardware processing units to provide the implicit feedback to a meeting evaluation module having a predictive algorithm trained to evaluate future meetings, and obtain an evaluation of an individual future meeting from the meeting evaluation module.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1, 4, and 7 illustrate example methods or techniques consistent with some implementations of the present concepts.

FIG. 2 illustrates an example environment consistent with some implementations of the present concepts.

FIG. 3 illustrates an exemplary meeting evaluation module consistent with some implementations of the present concepts.

FIGS. 5, 6, and 11 illustrate exemplary graphical user interfaces consistent with some implementations of the present concepts.

FIGS. 8-10 illustrate exemplary data structures consistent with some implementations of the present concepts.

### DETAILED DESCRIPTION

### Overview

In many different organizational contexts, people are faced with decisions about how to spend their time efficiently. For example, people working for a business, government entity, charity, etc., may have many different conflicting commitments and it can be difficult for these people to attend every meeting to which they are invited. The disclosed implementations provide an automated meeting evaluation module that can make recommendations to device users about which future meetings they should attend. For example, the meeting evaluation module can evaluate future meetings using various evaluation schemes and can also rank future meetings relative to one another.

Generally speaking, the disclosed implementations can use both implicit feedback and explicit feedback to train the meeting evaluation module to evaluate future meetings. For example, after attending a given meeting, a user may explicitly indicate whether the meeting was useful by providing input to a computing device such as a mobile phone or tablet. In some cases, the user may rate the meeting based on how useful the meeting was for the user. In other implementations, users can evaluate the meeting using other criteria, e.g., how informative the meeting was, how much they enjoyed the meeting, or any other characterization of the relative value of the meeting. In addition, in some cases, the user may choose not to attend a given meeting (e.g., by declining a meeting invitation), and this can serve as another form of explicit feedback.

When attending a given meeting, the user may carry the device during the meeting and the device may collect implicit feedback during the meeting. For example, the implicit feedback can indicate whether the user interacted with their device during the meeting (e.g., answering emails, web browsing), left the meeting location, turned their device on/off, etc. In addition, implicit feedback may also indicate that a user has chosen not to attend a given meeting (e.g., the user does not go to a meeting for which they have accepted an invitation). Both explicit feedback and implicit feedback relating to the previous meetings can be used to train the meeting evaluation module to evaluate future meetings.

For the purposes of this document, the following terminology is adopted. The term “meeting” encompasses both physical meetings where meeting participants are co-located at a given location (e.g., a conference room) as well as virtual meetings where meeting participants can be remotely located from one another and use information technology to conduct a meeting. The term “meeting” also encompasses partly-virtual meetings where some participants are physically co-located and other participants attend the meeting virtually. The term “explicit feedback” for a given meeting encompasses scenarios where users explicitly provide input characterizing the value of a meeting, e.g., an explicit meeting evaluation selected by the user or an input from the user declining to attend a given meeting. The term “implicit feedback” for a given meeting encompasses information that can be collected by a user device during a given meeting that does not involve the user explicitly characterizing the meeting.

The term “mapping algorithm” generally refers to a mechanism that can learn how implicit feedback maps to explicit feedback, as discussed more below. The term “predictive algorithm” generally refers to another mechanism that can be trained using explicit and/or implicit feedback to evaluate future meetings given attributes of the future meetings. Both the term “mapping algorithm” and “predictive algorithm” can encompass a broad range of machine learning/artificial intelligence techniques, including stochastic, probabilistic, heuristic, supervised, unsupervised, and/or partially-supervised techniques. In some implementations, a meeting evaluation module can have both a mapping algorithm and a predictive algorithm, as discussed more below.

### Meeting Evaluation Method

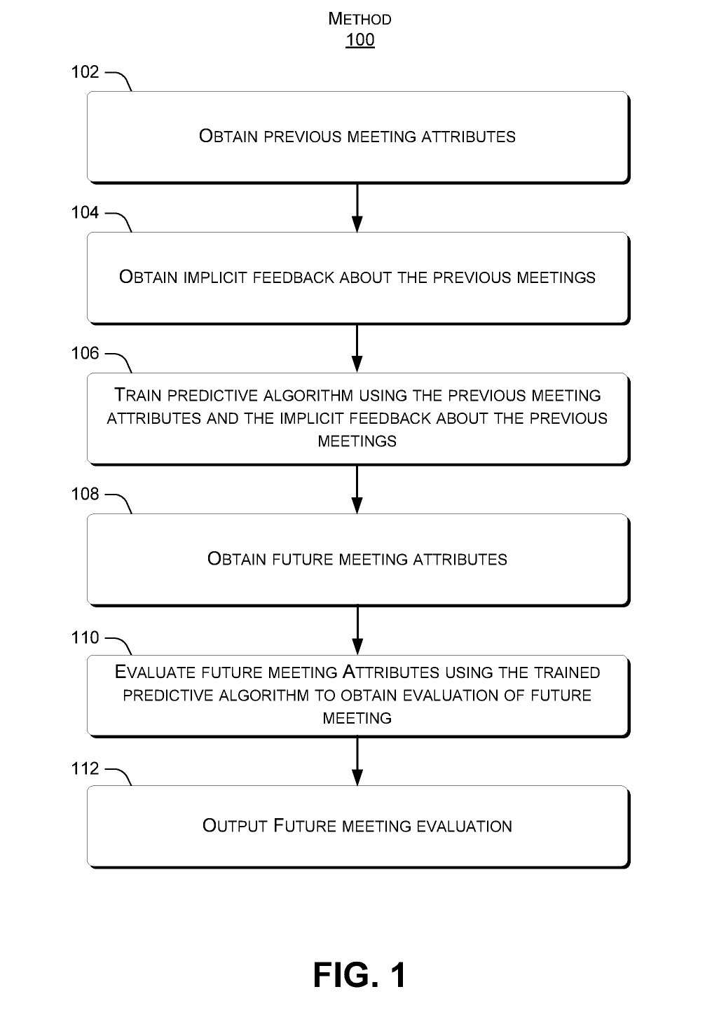

The following discussion presents an overview of functionality that can evaluate a future meeting, e.g., by predicting the likely utility of the future meeting for a particular user. FIG. 1 illustrates an exemplary such method 100, consistent with the present concepts. As discussed more below, the method can be implemented by a meeting evaluation module embodied on many different types of devices, e.g., by one or more cloud servers, by a client device such as a laptop, tablet, or smartphone, or by combinations of one or more servers, client devices, etc. In one specific scenario, a server device performs method 100 on behalf of a user that has a mobile client device such as a mobile phone, laptop, or tablet. In another specific scenario, the mobile device performs method 100 directly.

Method 100 begins at block 102, where attributes of previous meetings are obtained. For example, a user's calendar may identify various meetings that the user has attended (or chosen not to attend), and the method can identify certain attributes of these meetings. The identified attributes can indicate other participants that attended the meeting or chose not to attend the meeting, a title of the meeting, location of the meeting, etc. Additional examples of meeting attributes are discussed in more detail below.

Method 100 continues at block 104, where implicit feedback is obtained about the previous meetings. For example, the implicit feedback can indicate how the user interacted with a computing device during the previous meetings, whether the user moved to different locations during the meeting, whether the user spoke at the meeting, or even whether the user attended the meeting at all. Additional examples of implicit feedback are discussed in more detail below.

Method 100 continues to block 106, where a predictive algorithm is trained using explicit and/or implicit feedback and the meeting attributes. Generally, the predictive algorithm can learn how various meeting attributes tend to indicate whether a user will consider a given meeting to be useful or not. In some specific implementations, the predictive algorithm implements one or more supervised learning algorithms, as discussed in more detail below.

Method 100 continues to block 108, where attributes of a future meeting are obtained. For example, the future meeting may be a meeting for which the user has received an invitation. The future meeting attributes obtained at block 108 can be similar to those obtained at block 104 for the previous meetings.

Method 100 continues at block 110, where the trained predictive algorithm evaluates the future meeting based on the attributes of the future meeting. In some implementations, the evaluation can identify an expected utility of the future meeting to the user.

Method 100 continues at block 112, where the future meeting evaluation is output by the trained predictive algorithm. For example, in some cases, a user interface may be generated that displays the evaluation of the future meeting as determined by the trained predictive algorithm. In other cases, some additional processing may be applied to the evaluation before the output is displayed. In some specific implementations, various future meetings are ranked relative to one another based on evaluations by the trained predictive algorithm, and a user interface reflecting the relative rankings is generated.

### Cloud Scenario

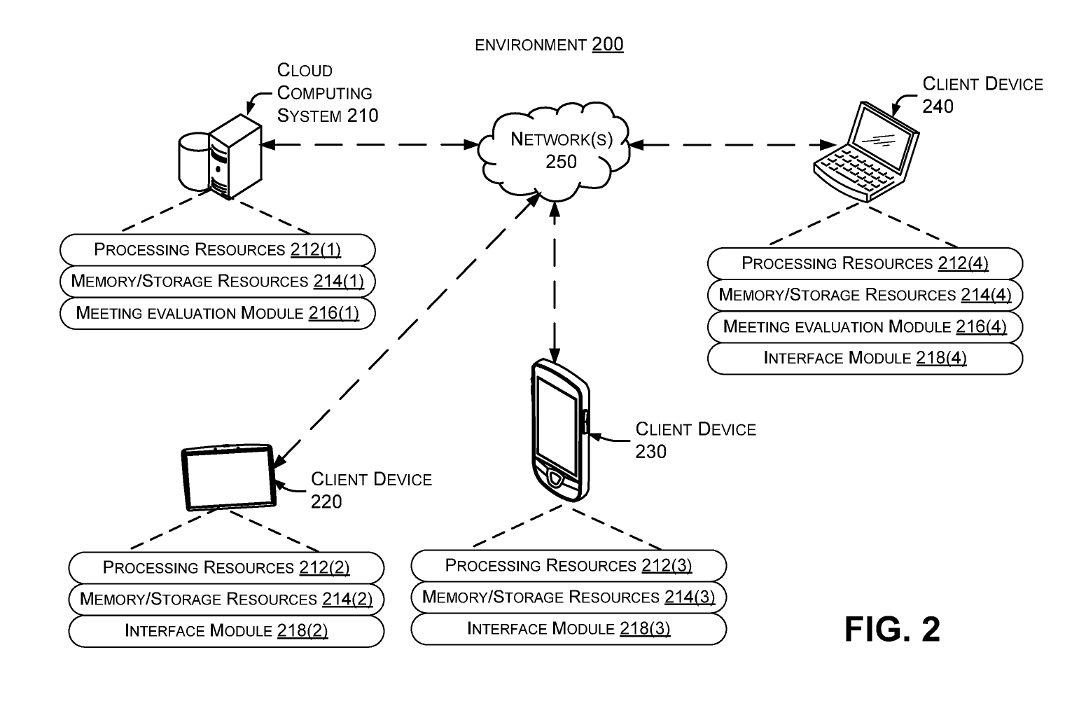

Method 100 can be performed in various scenarios, including locally on a client device as well as by a cloud service that performs the method remotely from user devices. Consider FIG. 2, which shows an example environment 200 including a cloud computing system 210 connected to a tablet client device 220, a mobile phone client device 230, and a laptop client device 240. Note that client devices can be embodied both as mobile devices as shown in FIG. 2 as well as stationary devices such as desktops, other server devices, etc.

Certain components of the cloud computing system 210 and/or client devices 220-240 may be referred to herein by parenthetical reference numbers. For the purposes of the following description, the parenthetical (1) indicates an occurrence of a given component on the cloud computing system 210, (2) indicates an occurrence of a given component on the client device 220, (3) indicates an occurrence on client device 230, and (4) indicates an occurrence on client device 240. Unless identifying a specific instance of a given component, this document will refer generally to the components of the cloud computing system and client devices without the parenthetical.

Generally, the cloud computing system 210 and client devices 220, 230, and 240 may have respective processing resources 212 and memory/storage resources 214, which are discussed in more detail below. The cloud computing system and client devices may also have various modules that function using the processing and memory/storage resources to perform the techniques discussed herein, as discussed more below.

Consider first a client-server scenario. Cloud computing system 210 may include a meeting evaluation module 216(1) that provides meeting evaluation functionality on behalf of users of the client devices. The client devices 220, 230, and 240 may have corresponding instances of an interface module 218 that are configured to interact with the meeting evaluation module 216. For example, the interface module may communicate data such as explicit meeting feedback, implicit meeting feedback, and/or meeting attributes for both previous and future meetings to the meeting evaluation module 216(1). In addition, the interface modules may display various outputs of the meeting evaluation module, such as individual future meeting evaluations as well as rankings of various future meetings relative to one another.

Alternatively, consider a local meeting evaluation scenario where a given client device can perform some or all of the meeting evaluation functionality thereon. This is illustrated in FIG. 2 with client device 240, which has a local instance of a meeting evaluation module 216(4). Furthermore, note that the disclosed techniques can be performed entirely by a single meeting evaluation module, and can also be distributed so that parts of the disclosed techniques are performed by one meeting evaluation module and other parts are performed by a different meeting evaluation module, as discussed more below.

### Example Meeting Evaluation Module

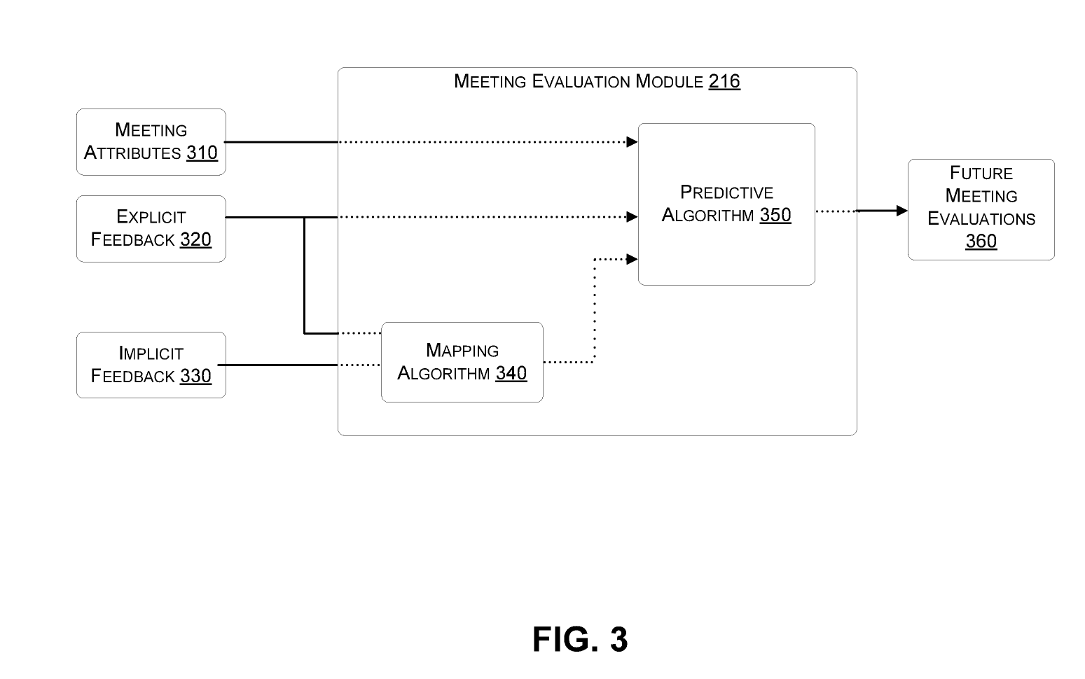

FIG. 3 illustrates an exemplary meeting evaluation module 216 that can be used to implement method 100. Generally, meeting evaluation module 216 can receive input data such as meeting attributes 310, explicit feedback 320, and implicit feedback 330, e.g., from interface module 218. Meeting evaluation module 216 can also include a mapping algorithm 340 and a predictive algorithm 350 that collectively operate on the input data to learn to evaluate future meetings and thus produce future meeting evaluations 360.

In some implementations, both the mapping algorithm 340 and the predictive algorithm 350 can be part of a single meeting evaluation module 216 running on a server device (e.g., cloud computing system 210), but in other implementations, these are provided on the client device. In still further implementations, the mapping algorithm is performed on a server device while the predictive algorithm is performed on a client device, or vice-versa. In addition, the meeting attributes, explicit feedback, and implicit feedback can be provided from an interface module 218 on a given client device to a remote meeting evaluation module that executes on a different computing device, or alternatively can be provided to a local meeting evaluation module that executes on the client device.

Meeting evaluation module 216 can function in a training configuration where the input data relates to previous meetings and is used to train the mapping algorithm 340 and the predictive algorithm 350. Once trained, the meeting evaluation module can function in an evaluation configuration where the input data relates to future meetings that are evaluated using the meeting evaluation module. The evaluation configuration can produce future meeting evaluations 360.

In the training configuration, meeting attributes 310 are attributes of various meetings that a user has previously attended. Explicit feedback 320 can include explicit user evaluations of these previous meetings, e.g., as entered by the user into a graphical user interface of a computing device. Explicit feedback can also indicate whether a user has accepted or declined an invitation to a given meeting. Implicit feedback 330 can include information determined by the user's device during the meetings, such as application usage by the user, communications by the user, movements by the user, whether the user actually attended a given meeting, etc.

In the training configuration, mapping algorithm 340 learns how the implicit feedback maps to the explicit feedback provided by the user. For example, the implicit feedback may indicate whether the user engaged in various activities such as web browsing or emailing during the meeting. The explicit feedback may indicate an evaluation (e.g., a rating) assigned to each individual meeting by the user. For example, if the user spent a lot of time web browsing or emailing in meetings that he tends to assign relatively low ratings to, then the mapping algorithm may learn that web browsing and emailing are indicative of meetings with relatively low utility for the user. Note, however, that the converse may be true, e.g., another user may tend to assign relatively high ratings to meetings where the user sends emails and browses the web, and for that user the mapping algorithm may learn that emailing and web browsing are indicative of high-value meetings for that user. Thus, it can be useful to train the mapping algorithm specifically for each individual user.

In the training configuration, predictive algorithm 350 can learn to use meeting attributes for previous meetings as well as implicit or explicit feedback for those meetings to learn to evaluate future meetings. For example, certain meeting attributes may be indicative that the user will likely view a meeting as particularly useful, e.g., some users may view meetings with their human resources department to be particularly useful. On the other hand, other users may view meetings with the human resources department as relatively unimportant. Thus, it can also be useful to train the predictive algorithm for each individual user.

Once training has been accomplished, the meeting evaluation module 216 can operate in the evaluation configuration. In the evaluation configuration, the predictive algorithm can obtain attributes of future meetings and output future meeting evaluations 360. Note that the evaluation configuration does not necessarily involve the mapping algorithm 340, e.g., when as the future meeting attributes are available, the trained predictive algorithm 350 can evaluate the future meetings without involvement of the mapping algorithm. Thus, some implementations may initially train the predictive algorithm on a server device and, once trained, instantiate the trained predictive algorithm on the client device.

The configuration of meeting evaluation module 216 shown in FIG. 3 may allow training to proceed effectively with a relatively sparse amount of explicit user feedback. Consider an alternative approach where the user enters explicit feedback for each meeting they have attended and the predictive algorithm is trained only using the explicit feedback. This approach may involve more extensive user effort because the user would be expected to explicitly evaluate each meeting they attend.

Instead, meeting evaluation module 216 can use the mapping algorithm 340 to learn how various implicit feedback signals indicate whether a meeting is truly useful to a user. The user may only provide explicit feedback evaluations on a relatively small subset of the previous meetings, and the mapping algorithm can be used to label a remainder of the previous meetings with evaluations based on implicit feedback for the remainder of the meetings. Thus, only a subset of the meetings used to train the predictive algorithm 350 are explicitly labeled by the user, and the others can be labeled by the trained mapping algorithm.

### Feedback Mapping Method

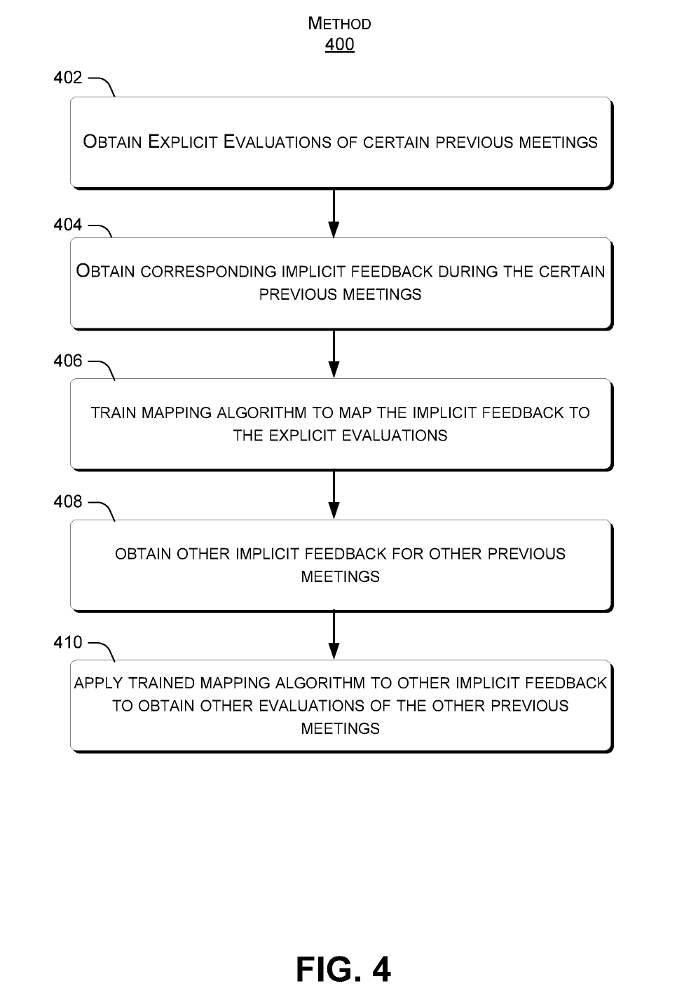

The following discussion presents an overview of functionality that can be used to map implicit feedback to explicit feedback. FIG. 4 illustrates an exemplary method 400 consistent with the present concepts. In some implementations, method 400 is performed by mapping functionality on a server or client device, e.g., as discussed herein with respect to mapping algorithm 340. Viewed from one perspective, method 400 can be considered part of block 106 of method 100, e.g., training a predictive algorithm. More specifically, mapping implicit to explicit feedback can be used as a mechanism to obtain training data for predictive algorithm 350, which, once trained, can be used to evaluate future meetings.

Method 400 begins at block 402, where explicit evaluations of certain previous meetings are obtained. For example, as discussed more herein, a user may provide a usefulness rating indicating how useful they felt a particular meeting was using a computing device. The evaluation can be represented in various forms, such as using a Boolean (e.g., useful/not useful) value, a real number, an enumerated set of values (e.g., very likely to be not useful, somewhat likely to be not useful, neutral, somewhat likely to be useful, and very likely to be useful), etc.

Method 400 continues at block 404, where implicit feedback is obtained that corresponds to the meetings for which explicit evaluations have been obtained. For example, as noted elsewhere herein, the implicit feedback can indicate both how the user interacted with their device (e.g., user inputs to various applications) as well as indicate values obtained by various device sensors for these meetings (e.g., accelerometer, GPS, microphone, power on/off, etc.).

Method 400 continues at block 406, where a mapping algorithm is trained to map the implicit feedback to the explicit evaluations. As discussed elsewhere herein, in some cases the mapping algorithm is a supervised learning algorithm such as a decision tree, random forest, etc. Generally, the inputs to the mapping algorithm include implicit feedback values, and the outputs of the mapping algorithm include meeting evaluations such as usefulness ratings. In some cases, the mapping algorithm outputs are from the same domain as the explicit feedback received from the user.

Method 400 continues at block 408, where other implicit feedback is obtained for other previous meetings, e.g., meetings for which the user has not provided explicit feedback. The implicit feedback obtained at block 408 can otherwise be similar to the implicit feedback obtained at block 404 and as discussed elsewhere herein.

Method 400 continues at block 410, where the trained mapping algorithm is applied to the other implicit feedback to obtain evaluations of the other previous meetings that have not been explicitly evaluated by the user. In some cases, the evaluations obtained at block 410 are represented similarly to the evaluations obtained at block 402, e.g., as Boolean values, real numbers, enumerated values, etc.

### Explicit Feedback GUI

As discussed above with respect to block 402 of method 400, one way to collect explicit feedback 320 from the user is via a computing device. Generally speaking, the explicit feedback can be provided in various representations, ranging from simple Boolean values (e.g., useful or not useful) to more refined representations such as numeric scales (e.g., real numbers, integers, etc.). In some implementations, users can provide the explicit feedback via a graphical user interface (“GUI”) on any of client devices 220, 230, and/or 240.

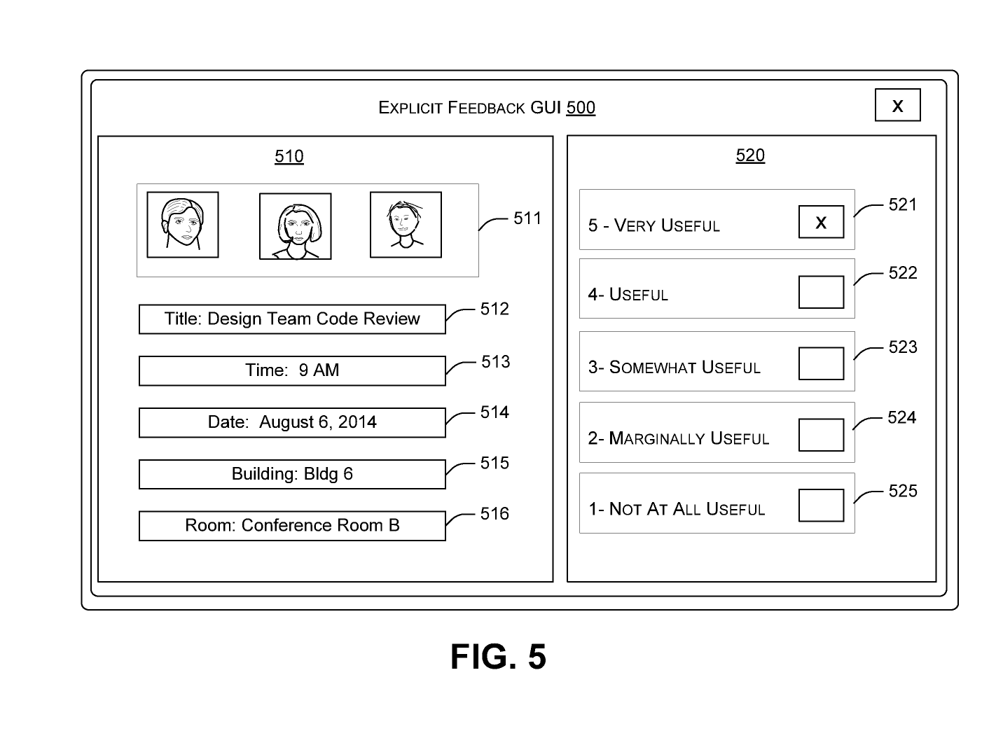

FIG. 5 illustrates an exemplary explicit feedback GUI 500 consistent with certain implementations of the present concepts. GUI 500 can generally include an attribute section 510 listing various attributes of a meeting that the user has attended. GUI 500 can also include a feedback section 520 listing various feedback options for the user to rate the meeting.

Attribute section 510 can include various meeting attributes such as participants 511, title 512, time 513, date 514, building 515, and room 516. In this example, the attributes relate to a meeting that took place on Aug. 6, 2014 at 9 AM with three other participants in Building 6, Conference Room B. Note that these meeting attributes are exemplary and additional meeting attributes will be discussed in more detail below. Feedback section 520 can include various selectable feedback options 521-525, ranging from “not at all useful” to “very useful.” In this example, the user has selected “very useful” option 521 for the meeting.

Note that interfaces such as GUI 500 can also be used to collect explicit feedback for meetings that a user chooses not to attend. For example, the user may decide that a given future meeting is likely to be not at all useful, and decline a meeting invitation for the meeting. In some cases, when a user declines a meeting invitation, they are prompted via GUI 500 to provide explicit feedback for the declined meeting. In other implementations, the act of the user declining the meeting itself is used as negative explicit feedback and the declined meeting can be labeled as not at all useful or another similar value.

In some implementations, the interface module 218 can generate GUI 500 and display the GUI on a corresponding client device. When the meeting evaluation module 216 is embodied remotely from the client device, the interface module can communicate the feedback option selected by the user via GUI 500 over network 250 to the computing device that executes the meeting evaluation module (e.g., to cloud computing system 210/meeting evaluation module 216(1)). In cases where the meeting evaluation module is located on the client device, the interface module can store the selected feedback option on the client device in memory/storage resources 214 for subsequent processing by the local meeting evaluation module.

### Implicit Feedback GUI

As discussed above with respect to block 404 of method 400, one way to collect implicit feedback about a given meeting is via a computing device that is present with the user during the meeting. For example, consider a mobile phone or tablet of a user with a suite of applications such as email, a web browser, games, document editors, social networking apps, etc. Such a device may also have a variety of sensors such as location sensors (e.g., GPS, Wi-Fi location), an accelerometer, a microphone, a camera, a touch screen, etc. The user's interactions with the device applications and/or sensors during a given meeting can be used as implicit feedback about how useful the meeting is to the user, as discussed more below.

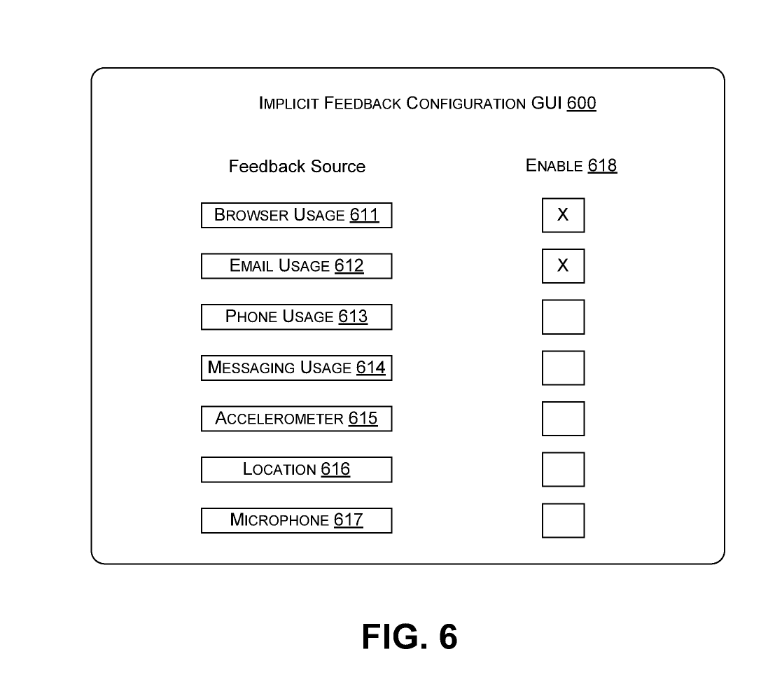

FIG. 6 illustrates an exemplary implicit feedback configuration GUI 600 consistent with certain implementations of the present concepts. GUI 600 identifies configurable feedback sources such as browser usage 611, email usage 612, phone usage 613, messaging usage 614, accelerometer 615, location 616, and microphone 617. Generally, by selecting a corresponding enable option 618, the user can configure the interface module 218 on their device to collect the corresponding type of implicit feedback.

For example, by enabling browser usage 611, the user can configure the interface module on their device to monitor their usage of a web browser during meetings. Likewise, by enabling email usage 612, the user can configure the interface module on their device to monitor their usage of an email application during meetings. By enabling phone usage 613, the user can configure the interface module on their device to monitor their phone usage during meetings. By enabling messaging usage 614, the user can configure the interface module on their device to monitor usage of messaging applications such as short message service (SMS) or multimedia messaging service (MMS) during the meetings. By enabling accelerometer 615, the user can configure the interface module on their device to monitor accelerometer outputs during the meetings. By enabling location 616, the user can configure the interface module on their device to monitor their location via GPS, Wi-Fi, or other techniques during the meetings. By enabling microphone 617, the user can configure the interface module on their device to turn on the device microphone during meetings (e.g., for analysis of sound as discussed more below).

In implementations where the meeting evaluation module is embodied on a server remote from the client device, the interface module 218 can communicate data from the implicit feedback sources selected by the user to the meeting evaluation module via a network 250. In cases where the meeting evaluation module is implemented directly on the client device, feedback from the selected implicit feedback sources can stored on the client device in memory/storage resources 214 for subsequent processing by the local meeting evaluation module.

In some implementations, the interface module 218 on a given client device can be configured to interact with a local calendar or other scheduling application on the client device to determine when to monitor for implicit feedback. For example, the interface module can identify specific meetings on the local calendar and activate the implicit feedback sources during those meetings. For example, if the user has enabled the microphone for implicit feedback, the interface module can activate (e.g., unmute) the microphone during the meeting and deactivate the microphone at the scheduled conclusion of the meeting. In physical meeting scenarios, the interface module may activate the implicit feedback sources responsive to detecting that the user is arriving at the location of the physical meeting. In virtual meeting scenarios, the interface module may activate the implicit feedback sources responsive to detecting that the user has entered the virtual meeting, e.g., by communicating with a virtual meeting application with which the user is conducting the virtual meeting.

### Interface Method

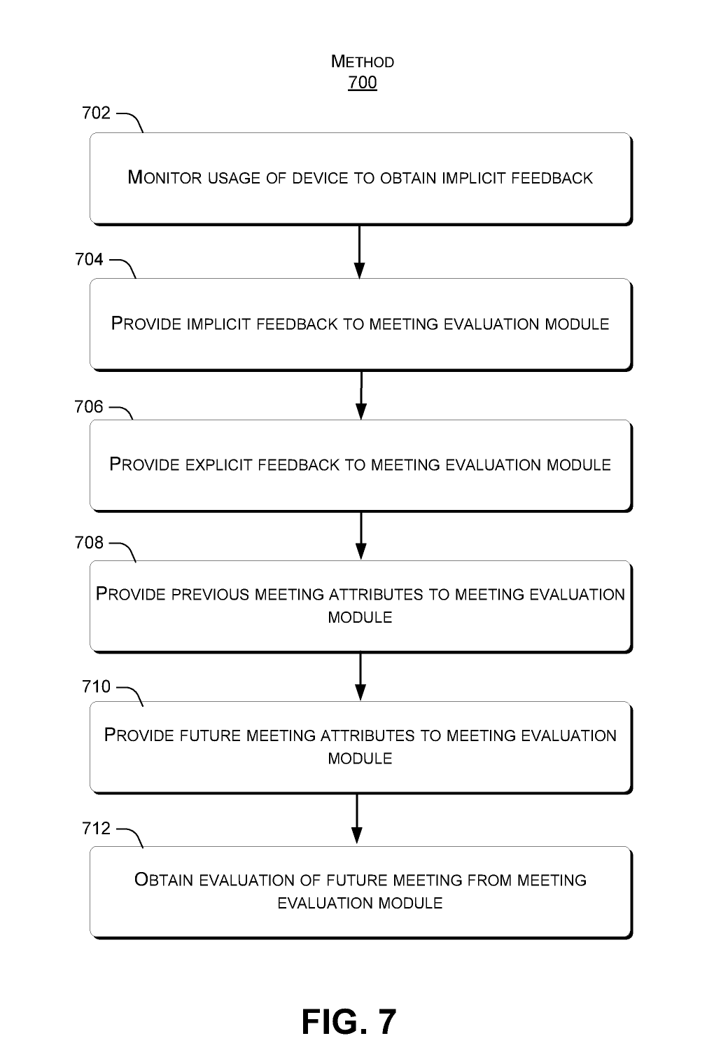

As discussed above, some implementations of the disclosed techniques involve interface functionality that interacts with a remote or local meeting evaluation module. FIG. 7 illustrates an exemplary method 700 consistent with the present concepts. In some implementations, method 700 is performed by client-side functionality on client device, e.g., as discussed herein with respect to interface module 218.

Method 700 begins at block 702, where the user's device is monitored for implicit feedback. For example, the interface module 218 on a user's device can actively monitor user inputs, device sensor values, etc., during various physical and virtual meetings, and store the implicit feedback for later reference.

Method 700 continues at block 704, where the implicit feedback is provided to a meeting evaluation module. For example, the implicit feedback can be communicated as a given meeting is ongoing or can be communicated at some later time.

Method 700 continues at block 706, where explicit feedback for previous meetings is provided to the meeting evaluation module. For example, as discussed herein, user evaluations of various meetings can be obtained via an interface such as GUI 500. Note that the explicit feedback is not necessarily obtained for all of the meetings that were monitored for implicit feedback, as discussed elsewhere herein.

Method 700 continues at block 708, where previous meeting attributes are provided to the meeting evaluation module. For example, attributes for both the explicitly-evaluated previous meetings and other previous meetings that the user has not explicitly evaluated can be provided to the meeting evaluation module. The attributes can be obtained by the interface module 218 by accessing various data sources, such as a user calendar or schedule on the client device. In other implementations, the interface module obtains the attributes from a cloud-based calendar or schedule and then provides the attributes to the meeting evaluation module and/or the meeting evaluation module can obtain the attributes directly.

Method 700 continues at block 710, where attributes of a future meeting are provided to the meeting evaluation module. For example, the future meeting attributes can be obtained in a similar manner to the attributes of the previous meetings, e.g., by accessing a local or remote user calendar/schedule.

Method 700 continues at block 712, where an evaluation of the future meeting is received from the meeting evaluation module. As discussed more herein, the evaluation can be obtained in various forms, including via a graphical user interface that conveys the evaluation.

At a high level, method 700 can be viewed as complementary to the training phases and evaluation phases discussed above with respect to meeting evaluation module 216. Generally, blocks 702-708 can correspond to the training phase, since these blocks relate to providing training data to the meeting evaluation module. Blocks 710 and 712 relate to the evaluation phase, since these blocks are performed after the mapping algorithm 340 and predictive algorithm 350 are trained to obtain evaluations of future meetings that can guide decision making by the user for which future meetings to attend.

In implementations where the meeting evaluation module 216 is embodied on the client device with the interface module 218, a shared memory or storage device can be used to communicate the explicit feedback, implicit feedback, and/or previous/future meeting attributes to the meeting evaluation module, as well as to receive the evaluation of the future meeting from the meeting evaluation module. In other implementations, the meeting evaluation module can be located remotely, in which case the explicit feedback, implicit feedback, meeting attributes, and/or evaluations can be communicated to/from the remote meeting evaluation module using a packetized data stream such as a TCP/IP or UDP/IP stream.

### Specific Data Examples

The following sections introduce some specific data examples to refine the concepts introduced above. In the following examples, 15 meetings are discussed, numbered 1-15. Meetings 1-5 are previous meetings that a user has attended, for which the user has provided explicit feedback, and for which implicit feedback is also available. Meetings 6-10 are previous meetings that the user has attended and for which implicit feedback is available, but for which the user has not provided explicit feedback. Meetings 11-15 are future meetings that will be evaluated as discussed more below.

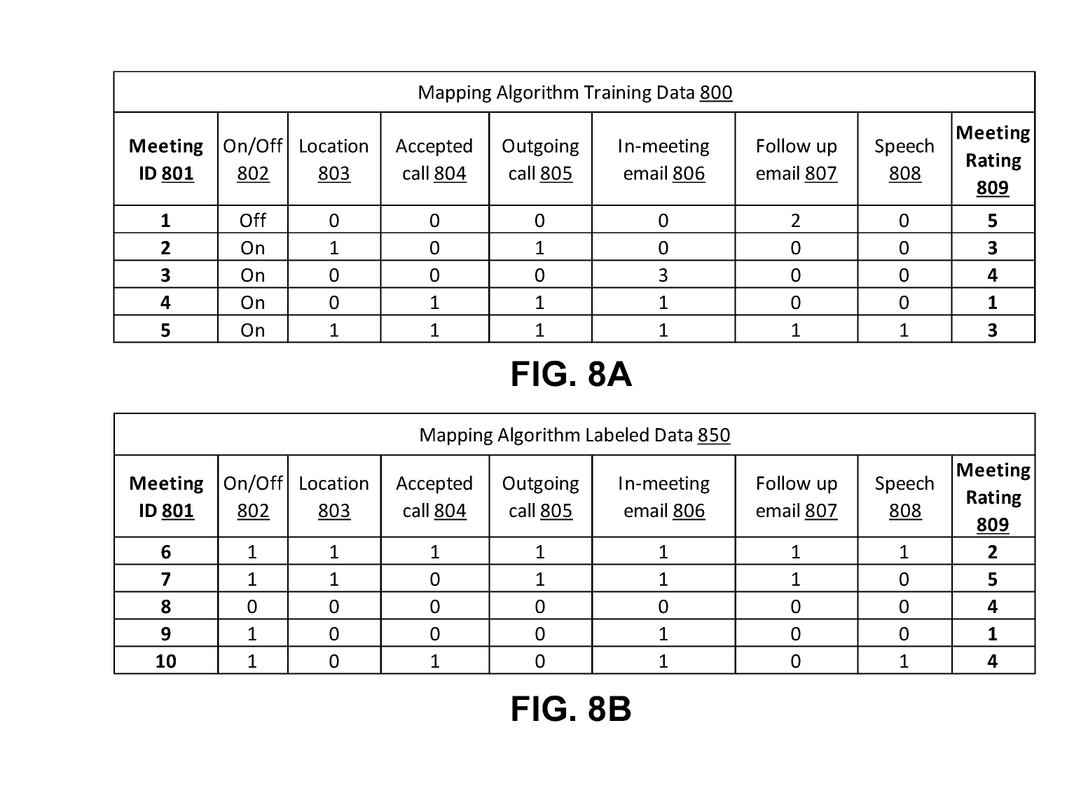

FIG. 8A shows exemplary mapping algorithm training data 800, which includes fields such as meeting ID 801, implicit feedback values 802-808, and meeting rating 809. Meeting ID 801 identifies the five meetings for which the user has provided explicit feedback. During these meetings, the user's device recorded the corresponding implicit feedback values 802-808. Thereafter, the user provided the meeting ratings 809 as explicit feedback. Mapping algorithm training data 800 is one example of the type of data that can be used to train mapping algorithm 340, and includes examples of the explicit evaluations (e.g., meeting ratings 809) obtained at block 402 of method 400 and examples of the implicit feedback (e.g., implicit feedback values 802-808) obtained at block 404 of method 400.

Implicit feedback values 802-808 can generally be any values detectable by the user's device during a given meeting, and the examples shown in FIG. 8A are merely exemplary. In FIG. 8A, the implicit feedback values include an on/off field 802 indicating whether the user's device was powered on or off during the corresponding meeting. The implicit feedback values also include a location field 803 indicating whether the user stayed at the meeting location for the duration of the meeting. The implicit feedback values also include an accepted call field 804 indicating whether the user accepted a telephone call with their device during the meeting and an outgoing call field 805 indicating whether the user made an outgoing call during the meeting. The implicit feedback values can also include an in-meeting email field 806 indicating a number of emails that the user sent with their device during the meeting. In addition, the implicit feedback values can include a follow-up email field 807 indicating a number of follow-up emails sent by the user after the meeting (e.g., to another meeting participant). The implicit feedback values can also include a speech field 808 indicating whether the user spoke at the meeting. Further details on implicit feedback values are discussed more below.

Once mapping algorithm training data 800 has been used to train the mapping algorithm 340, the mapping algorithm can be used to evaluate other meetings for which implicit feedback is available e.g., meetings 6-10 in this example. FIG. 8B illustrates mapping algorithm labeled data 850, which is generally similar to mapping algorithm training data 800. However, in this case, the meeting ratings 809 are provided by the mapping algorithm instead of by explicit user feedback.

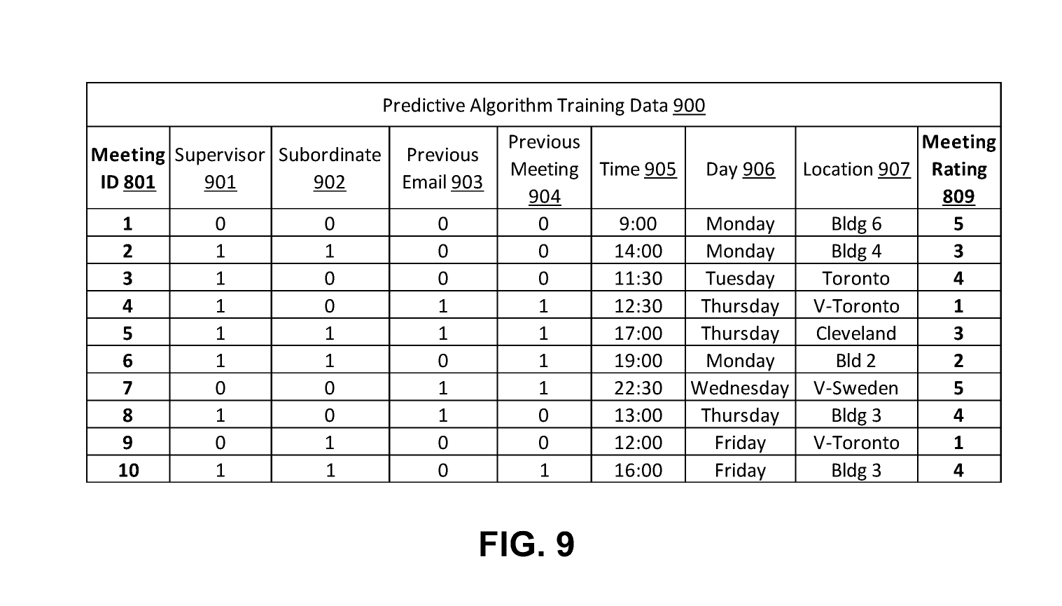

Both explicitly-labeled meetings 1-5 and machine-labeled meetings 6-10 can be used as training data for the predictive algorithm 350. FIG. 9 shows exemplary predictive algorithm training data 900, which generally includes meeting ID field 801 and meeting rating field 809 as already discussed. Predictive algorithm training data 900 also includes meeting attribute fields 901-907. Generally, the meeting attributes can represent any characteristics of a given meeting, and the examples shown in FIG. 9 are merely exemplary. Predictive algorithm training data 900 is one example of the type of data that can be used to train predictive algorithm 350, and includes examples of previous meeting attributes (fields 901-907) obtained at block 102 of method 100 and provided at block 708 of method 700.

In FIG. 9, the predictive algorithm training data 900 includes a supervisor field 901 that indicates whether a user's supervisor is a meeting participant. The predictive algorithm training data also includes a subordinate field 902 that indicates whether any of the user's subordinates is a meeting participant. The predictive algorithm training data also includes a previous email field 903 indicating whether the user has sent a previous email to another meeting participant. The predictive algorithm training data also includes a previous meeting field 904 indicating whether the user had a previous meeting with another meeting participant. The predictive algorithm training data also includes a time field 905 indicating a time of day when the meeting took place. The predictive algorithm training data also includes a day field 906 indicating days of the week for each meeting. The predictive algorithm training data also includes a location field 907 indicating a location for each meeting. Note that, in FIG. 9, locations are prefaced with a “V-” to indicate the meeting is a virtual meeting where the meeting organizer is located remotely.

As noted above, the predictive algorithm training data 900 includes both explicitly-assigned meeting ratings for meetings 1-5 and machine-assigned meeting ratings for meetings 6-10. Thus, the user does not need to provide explicit evaluations of every previous meeting because the mapping algorithm 340 has learned to label some of the meetings based on implicit feedback. In some cases, the predictive algorithm is similar to the mapping algorithm, e.g., decision trees can be used for both mapping and prediction, random forests can be used for both, etc. In other implementations, the predictive algorithm is a different type of algorithm than the mapping algorithm, e.g., a random forest for mapping and a decision tree for predicting and/or vice versa. Generally, the inputs to the predictive algorithm can include meeting attributes, and the outputs of the predictive algorithm can include meeting evaluations. In some cases, the meeting evaluations output by the predictive algorithm are from the same domain as the explicit user feedback and/or the outputs of the mapping algorithm.

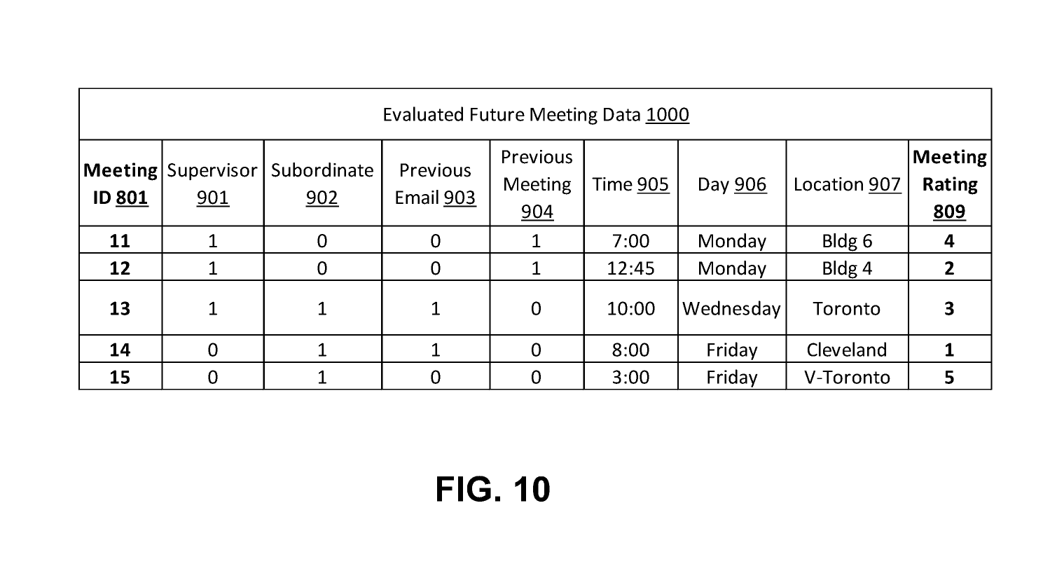

Once the predicting algorithm has been trained, future meetings can be evaluated. FIG. 10 shows exemplary evaluated future meeting data 1000 for future meetings 11-15. Generally, the fields of evaluated future meeting data 1000 are similar to those of predictive algorithm training data 900 as discussed above. However, meeting rating 809 is provided by the trained predictive algorithm 350 for future meetings 11-15, instead of by explicit user labeling as in previous meetings 1-5 or mapping algorithm labeling as in previous meetings 6-10.

### Additional Implicit Feedback Details

As noted above, many different types of signals obtainable by a device can be used for implicit feedback. FIGS. 8A and 8B show one exemplary set of implicit feedback values 802-808. However, note that many different types of signals obtainable by a user's device can be used as implicit feedback. Implicit feedback values 802-808 are exemplary and various different signals represented as various different data types can be used alternatively or in addition to the examples shown in FIGS. 8A and 8B.

The following discussion expands on how various implicit feedback values can be derived and represented. Consider on/off field 802 indicating whether a user's device is on or off during a meeting. In some implementations, this is represented as a Boolean “on/off” value. This value can be derived in various ways to deal with circumstances where the device is both on and off at different times during the meeting. In some implementations, whichever state the device is in for the majority of the meeting is used as the value of the on/off field, e.g., if the device is powered off for the majority of the meeting then the value is “off” and otherwise the value is “on.” Further implementations may use “off” as the value whenever the device is powered off for at least some portion of the meeting, whereas other implementations may do so when the amount of time the device is powered off exceeds some time threshold (e.g., 10 minutes). In still further implementations, a range of values is used to express the relative amount of time that a device is off or on during a meeting, e.g., a percentage or ratio.

Consider also location field 803 which represents whether the user left the meeting location during the meeting. In some implementations, this can be a Boolean value indicating whether, at any time during the meeting, the user left the room where the meeting took place, e.g., 1 indicating yes and 0 indicating no. For virtual meetings, the value can indicate whether the user moved away from another device used to conduct the virtual meeting, e.g., away from a desktop or laptop computer in their office. In a manner similar to that discussed above for on/off field 802, some implementations may determine whether the user has moved away from the physical meeting room or device conducting the virtual meeting for a threshold period of time (e.g., 10 minutes) before indicating that the user has left the meeting.

In determining location field 803, some implementations may apply a threshold distance to determine whether the user has left the meeting, e.g., 100 meters away from the physical meeting room or from a device conducting the virtual meeting. Further implementations may utilize both threshold distances and times, e.g., if the user is more than 100 meters away from the meeting (or virtual meeting device) for more than 10 minutes, the user is deemed to have left the meeting. More refined values can also be used to represent a user's presence at a meeting. For example, the implicit feedback can represent a ratio or percentage of time that a user is within a threshold distance of the physical meeting room and/or device conducting the virtual meeting.

Consider also accepted call field 804 and outgoing call field 805, which can represent whether the user accepted a call and/or made an outgoing call during the meeting, respectively. In some implementations, these are represented as Boolean values so that if the user accepts one or more incoming calls during the meeting a value of 1 is used and otherwise 0, and likewise for outgoing calls. In other implementations, a threshold amount of time spent on incoming/outcoming calls is used instead, e.g., five minutes, to distinguish instances where a user takes/makes a quick phone call (e.g., in which case 0 is used for these fields) versus instances where the user engages in lengthy conversations during the meeting (e.g., in which case 1 is used for these fields).

In further implementations, the number of accepted incoming and/or placed outgoing calls can be used instead of a Boolean value, e.g., the user may place three calls and accept two incoming calls during a meeting, in which case fields 804 and 805 would have values of 3 and 2, respectively. In still further implementations, the amount of time a user spends on an incoming/outgoing call can be expressed as a ratio/percentage of the length of the meeting. Also, note that some implementations do not distinguish between incoming and outgoing calls, e.g., these implementations may use a value of 1 or 0 indicating whether the user was on the phone at all during the meeting, a value of 5 indicating the user accepted/made a total of 5 calls during the meeting, a ratio/percentage of time the user spent on either incoming or outgoing calls, etc. Further implementations may also take into account whether the person calling or called by the user is also a meeting participant (either physical or virtual). For example, separate fields may be used to distinguish calls to/from other meeting participants from calls to/from people that are not meeting participants.

Email usage may be addressed in a manner similar to that discussed above with respect to phone calls using in-meeting email field 806. For example, some implementations may simply use a Boolean value indicating whether the user sent an email during the meeting. Other implementations may use a number of emails sent during the meeting. In addition, whether the email recipient is also a physical/virtual meeting participant can also be represented in the implicit feedback.

Further implementations may use more refined information such as the number of words written in the emails, analyzing the content of the emails, etc. For example, the content of the emails can be represented as a word vector indicating whether certain words appear in the emails. In some cases, the meeting title or other meeting information is also represented as another word vector for implicit feedback. This may help the mapping algorithm 340 to learn to distinguish instances where the user's emails are related to the meeting purpose from unrelated emails.

In addition, emails made after the meeting can also be used as implicit feedback and this can be represented using follow-up email field 807. For example, this field can indicate whether the user emails or receives an email from another meeting participant within a threshold period of time after the meeting ends. In some cases, a Boolean value is used to indicate whether any follow-up emails were sent at all, and in other implementations the number of follow-up emails, word count, etc. Further implementations may analyze substantive content of the follow-up emails in a manner similar to that discussed above with respect to in-meeting email field 806. In addition, follow-up phone calls can also serve as implicit feedback, e.g., whether and/or how many phone calls the user placed/received from other meeting participants within a given amount of time after the meeting.

In still further implementations, the implicit feedback can represent whether the user spoke at the meeting, e.g., using speech field 808. The interface module 218 can turn on the device microphone at the scheduled time of the meeting or responsive to the user arriving at a physical meeting, and the microphone can be used to detect whether the user speaks at the meeting. In some cases, voice recognition is used to distinguish the user's voice from the voices of other users present (physically or virtually) at the meeting. In other cases, voice volume can be used to determine who is speaking, since presumably the device owner is closer to the microphone than other people at the meeting. Also, in the case of virtual meetings, the user may conduct the virtual device with one device (e.g., a laptop or desktop) and engage in other activities with another device (e.g., their phone). In such cases, implicit feedback can be collected from both devices, e.g., the laptop/desktop microphone can be used to determine whether the user is speaking and sending emails whereas the phone can be used to detect whether the user is making/receiving calls.

Some of the aforementioned implicit feedback values can be determined by using the scheduled meeting times, e.g., if the user left before the scheduled meeting time, made calls during the meeting, etc. The scheduled meeting times can be determined by the interface module 218 and/or meeting evaluation module 216 by accessing the user's schedule/calendar. Further implementations may use aggregate user device information to identify instances where meetings start early and/or end late, e.g., if a certain percentage (e.g., a majority) of user devices in a given meeting indicate those users left 30 minutes before the scheduled end of the meeting, these implementations may use the time when the user devices left the meeting as the meeting end time instead of the time indicated on the schedule.

Note that FIGS. 8A and 8B are exemplary and do not illustrate every type of implicit feedback that can be used. For example, some implementations may monitor application usage, e.g., using data indicating whether the user played a video game on their device during a given meeting or a more refined value indicating the extent to which they played the game (e.g., a percentage of time). Similar techniques can be applied to web browser usage or other applications. In some implementations, specific web sites/content accessed by the user can be evaluated using natural language techniques to determine whether the web sites/content are likely pertinent to the meeting.

### Additional Meeting Attribute Details

As noted above, many different types of meeting attributes can be used for training predictive algorithm 350 and for evaluating future meetings using the trained predictive algorithm. However, note that many different characteristics of meetings may be used with the disclosed techniques. Fields 901-907 are exemplary meeting attributes and various other meeting attributes represented as various different data types can be used alternatively or in addition to the examples shown in FIGS. 9 and 10.

The following discussion expands on the examples shown in FIGS. 9 and 10. For example, individual meeting attributes may represent whether particular individuals are meeting participants. For the purpose of this document, the term “meeting participant” can refer generally to people that actually attended a previous meeting, people who were invited to a previous meeting but did not attend, and/or people who are invited/expected to attend a future meeting. In the examples shown in FIGS. 9 and 10, supervisor field 901 and subordinate field 902 respectively indicate whether the user's supervisor and/or any of the user's subordinates are participants for a given meeting. In some cases, a Boolean value indicating yes/no as to whether the user's direct supervisor and/or direct subordinate is used. In other implementations, meeting attributes can identify the number of subordinates, supervisors, and/or colleagues (e.g., within a given team or business unit) that are participants in a given meeting.

In further implementations, certain meeting attributes can be obtained by accessing an organizational hierarchy. For example, in some cases, the organizational hierarchy can be used to characterize a relationship between the user and the meeting organizer. In some implementations, the meeting evaluation module 216 and/or interface module 218 can determine a distance between the user and the meeting organizer in the organizational hierarchy. The distance can be expressed as the number of layers to traverse the organizational hierarchy, starting with the user, to find a common supervisor of both the user and the meeting organizer. In other implementations, the meeting attributes reflect not only the relationship between the user and the meeting organizer, but also the relationships between the user and each participant in the meeting (e.g., again, expressed as a number of layers of the organizational hierarchy).

In addition, previous email field 903 can also indicate whether there are past email interactions between the user and the meeting organizer. For example, the user's email can be accessed to determine whether the user has sent and/or received emails from/to the meeting organizer. In some implementations, a Boolean value of yes or no is used, and in other implementations an email count and/or frequency is used. The meeting attributes may also indicate whether those previous emails were one-to-one or one-to-many, and/or may indicate how many recipients there were for each of the emails. In other implementations, the meeting attributes reflect not only the email communications between the user and the meeting organizer, but also the email communications between the user and each participant in the meeting. In addition, the meeting attributes can also reflect the substantive contents of the email communications. For example, certain words can be identified in the email communications between the user and the meeting organizer/other meeting participants and used to evaluate the emails. In some implementations, word vectors are used in a manner similar to that discussed above with respect to the mapping algorithm 340.

Previous meeting field 904 may indicate whether there are past meetings for which the participants included both the user and the meeting organizer and/or other meeting participants in a manner similar to that discussed above for email interactions. For example, a Boolean value can be used for the meeting organizer and/or each meeting participant indicating whether the user and the organizer/other participant have both also been participants in at least one previous meeting, and can also indicate the number of other participants at each meeting. Other implementations may identify the number of previous shared meetings and/or frequency with which the user and the other users/organizer are participants in previous meetings. In other implementations, titles or other text associated with the previous meetings can also be evaluated using natural language techniques such as the word vectors mentioned previously.

In addition, time field 905 can indicate the time of day when the meetings are scheduled, e.g., using clock times or more general designators such as morning, afternoon, evening, etc. The meeting attributes can also include a day field 906 that represents the particular day of the week on which the meeting occurs. Other representations for the meeting date can include Julian date, proximity to certain holidays, season (spring, summer, autumn, winter), etc.

Location field 907 can indicate the meeting location. For meetings at the same general facility as the user, the meeting location can be identified by the building number, conference room, etc. Physical meetings requiring the user to travel may be identified in a similar matter or more generically, e.g., by city. Virtual meetings may be identified in a similar fashion and are shown with a “V-” prefix in FIGS. 9 and 10, where the “V-” precedes the city where the meeting organizer originates the meeting, where the meeting organizer normally works, and/or where the meeting organizer intends to physically be when conducting the physical meeting.

Note that FIGS. 9 and 10 are exemplary and do not illustrate every type of meeting attribute that can be used to characterize a meeting. For example, meeting attributes can indicate whether the meeting includes participants from an external entity such as vendors other than the company holding the meeting. Meeting attributes can also indicate relative rankings of the individuals in the meeting within the organizational hierarchy, e.g., as designated by GS levels for a federal government meeting, military ranks for a military meeting, human-resources defined job designators, etc.

### Training Details

For simplicity, the previous discussion referred to training both the mapping algorithm 340 and predictive algorithm 350 for a single user. Likewise, the previous discussion also assumed that, at some point, both algorithms were trained and after that point training could stop. The following discussion goes into some further details on these points.

In some implementations, the mapping algorithm 340 and/or predictive algorithm 350 are trained completely separately for multiple users. In other words, explicit feedback and implicit feedback exclusive to a given user are used to train the mapping algorithm for that user, and other exclusive and implicit feedback are used to train the mapping algorithm for a different user. A similar approach can be used for the predictive algorithm. The explicit and implicit feedback for the other user can be obtained from a different device (e.g., the other user's personal device) and the evaluations provided by the meeting evaluation module can be provided to the device of the other user.

Other implementations may perform some training using data for multiple different users to obtain partially-trained mapping and/or predictive algorithms and then update the partially-trained algorithms to “customize” them for each individual user. For example, there may be a pool of explicitly-labeled meetings from multiple users that are used as an initial set of training data, and each user may also provide a few training examples of explicitly-labeled meetings. When training for a given user, the pool of explicitly-labeled meetings can be used as well as the explicitly-labeled meetings provided by that user.

In further implementations, certain types of users are identified according to their feedback (e.g., implicit and/or explicit) and training occurs for each individual user type. For example, clustering algorithms can be used to cluster users according to their feedback for given meetings. The mapping algorithm and/or predictive algorithms can be trained separately for each user cluster. Then, new users can be classified according to user type in a given user cluster and the trained mapping and/or trained predictive algorithms for that cluster can be used for the new user.

Also, note that training can continue to occur even after the predictive algorithm is trained and being used to evaluate meetings. For example, suppose the training algorithm rates a given meeting as marginally useful, but the user nevertheless decides to attend the meeting. The user may subsequently provide explicit feedback indicating that the meeting was very useful, and in that case the meeting may be used as another training example to update the predictive algorithm. In other implementations, the user's decisions as to which meetings to attend may be used for training refinement even in the absence of explicit user feedback. In other words, a user's decision to attend a future meeting predicted to be not at all useful may suggest that the prediction is incorrect and that the predictive algorithm should be refined.

In some cases, training takes place periodically. For example, users may generally be provided with future meeting evaluations for some time using the trained algorithms. At some point, new training data can be collected from the user by requesting that they provide explicit feedback for one or more meetings. For example, in some cases, training is performed on a recurring basis every few months, after every 50 meetings, etc. Meeting evaluations can be provided by the meeting evaluation module 216 for meetings that occur in between the training periods, and can also be provided for meetings that the user explicitly labels for training purposes.

In some cases, the meeting evaluation module 216 will request explicit feedback for certain meetings for which it does not have high confidence. For example, the mapping algorithm 340 may output both meeting evaluations and confidence values when labeling individual meetings. If the confidence value is relatively low for a given meeting, e.g., below a threshold, the meeting evaluation module may request that the user provide explicit feedback for that meeting and use the explicit feedback instead of the evaluation provided by the mapping algorithm.

Further implementations may also use an active learning technique by specifically identifying particular meetings that the user should attend. For example, the meeting evaluation module 216 can evaluate a number of future meetings and determine that the user should attend one or more of the future meetings. In some cases, the meeting evaluation module may select certain future meetings for the user to attend when the training data is relatively sparse in a given area. For example, if the user has never attended a meeting organized by a particular person or department, the meeting evaluation module may indicate that the user should attend one or more meetings organized by that person or department to obtain some relevant training data for that person/department.

### Meeting Evaluation Module Outputs

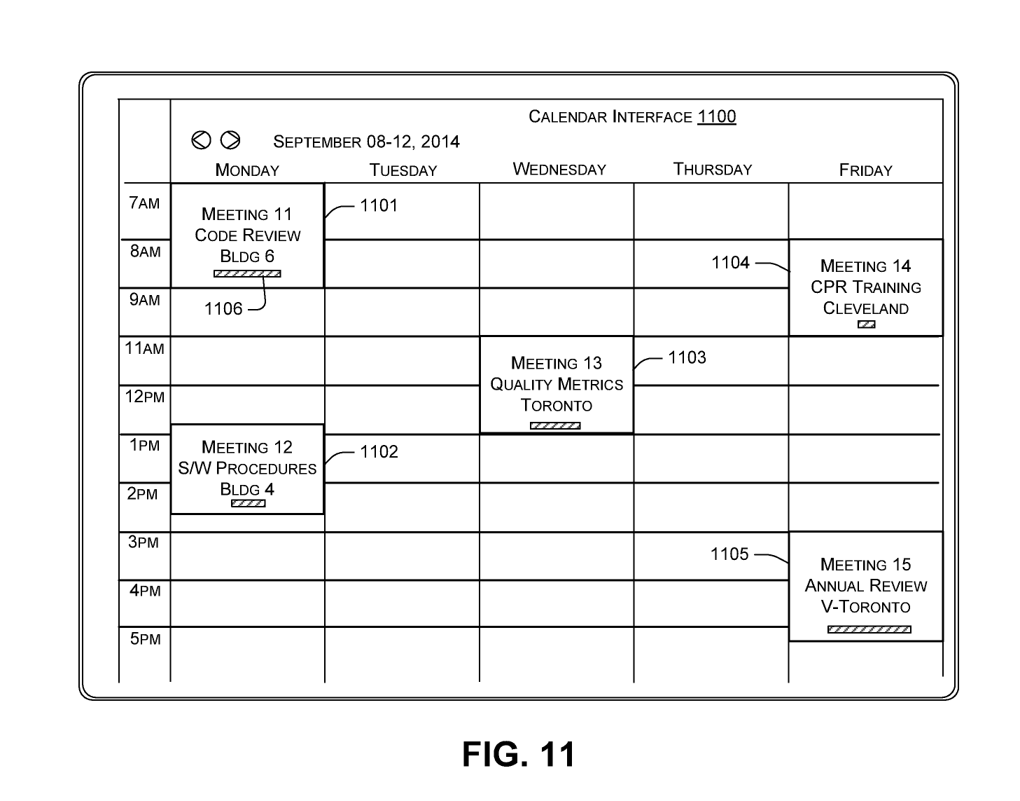

In some implementations, the evaluations provided by the meeting evaluation module 216 are output to the user. For example, the meeting evaluation module can generate various graphical user interfaces that convey the evaluations. FIG. 11 illustrates an exemplary calendar interface 1100 that shows entries 1101-1105 for future meetings 11-15, respectively. Each meeting entry can include a corresponding rating bar 1106, labeled only in entry 1101. The relative size (e.g., width) of the rating bar can convey the evaluation of the meeting. For example, meeting 15 was rated a “5” by the meeting evaluation component and meeting 14 was rated a “1,” so the width of the rating bar for entry 1105 is five times wider than the rating bar for entry 1104.

Of course, rating bar 1106 is just one graphical mechanism for conveying the evaluations provided by the predictive algorithm. Other implementations may directly show the evaluation, e.g., the number 5 can be shown in association with meeting 15 and the number 1 can be shown in association with meeting 14. Other implementations may use font size or other mechanisms to convey how different meetings are evaluated by the predictive algorithm. Such mechanisms for informing the user of the meeting evaluations can also be provided in other interfaces, e.g., with pop-up meeting reminders.

In addition, further implementations may rank certain meetings relative to one another and display a graphical interface indicating the ranking. In some cases the meeting evaluation module 216 and/or interface module 218 can automatically filter meetings from the user's schedule. For example, the user may be able to configure a specific setting for their calendar/scheduling application that removes meetings having evaluations below a threshold level. This may reduce the resource burden on the user's device (e.g., reduce processing, memory, and/or storage usage) because the user's device can automatically remove meetings from the schedule/calendar that have evaluations below the threshold. Since the user's device can simply delete these meetings, the user's device does not continue using processing, memory, and/or storage resources to maintain the deleted meetings on the schedule/calendar.

The meeting evaluation module 216 can also use the meeting evaluations to obtain organizational metrics. For example, the meeting evaluation module can use meeting ratings 809 as determined by explicit feedback (previous meetings 1-5), by the mapping algorithm (previous meetings 6-10), and/or by the predictive algorithm (future meetings 11-15) to determine the average usefulness of meetings. This can be performed in a general manner (e.g., for all meetings in a given organization), for various meeting topics (e.g., the average usefulness of software design review meetings, of supervisory reviews, of human resources meetings, etc.), for various meeting organizers, etc. In some cases, meeting organizers can be ranked relative to one another by the meeting evaluation module.

Likewise, the average usefulness of meetings can be determined for given parts of an organization. For example, the meeting evaluation module 216 can determine the average usefulness of meetings conducted by the human resources department, the legal department, and the payroll department of a given company. In some cases, the meeting evaluation module can also rank the departments relative to one another based on the average usefulness of the meetings that they conduct.

In addition, the meeting evaluation module 216 can be used to predict how likely a given person is to accept a meeting invitation. Consider a meeting organizer who is trying to decide which users to invite to a future meeting. Given attributes of the future meeting, the meeting evaluation module can apply the predictive algorithm 350, as trained for each different user, to determine how useful the meeting is likely to be to each user. For example, the meeting evaluation module can evaluate the future meeting for each email contact of the meeting organizer.

Next, the meeting evaluation module 216 can output the evaluations for each user and/or a list of recommended meeting attendees. To determine the recommended attendees, the meeting evaluation module (and/or interface module 218) can apply a threshold, e.g., each user for which the predicted meeting utility is at least a 4 out of 5 or “useful.” In some implementations, the meeting evaluation module and/or interface module can autopopulate a meeting invitation with the recommended attendees or can de-populate a meeting invitation (e.g., by removing meeting invitees that were initially added by the meeting organizer).

By aggregating the evaluations for a given future meeting, the meeting evaluation module 216 can also determine a predicted utility of the meeting. For example, if numeric evaluations are used, the mean and/or median evaluation value for all meeting invitees can be used as the predicted meeting utility. The meeting evaluation module may also recommend that certain meetings do not take place, e.g., meetings with an evaluation below a given threshold.

### Device Implementations

Referring back to FIG. 2, environment 200 as shown includes several devices. In this case, for purposes of explanation, the devices are characterized as client devices and a cloud computing system. In this example, the client devices are manifest as a smartphone, tablet, and laptop device. However, other types of devices can serve as client devices, such as desktop computers, printers, scanners, and/or computing-enabled home appliances. Generally, so long as a device has some computational hardware, the device can act as a client device in accordance with the disclosed implementations.

Cloud computing system 210 can include one or more cloud-based server type devices, although in some cases the cloud computing system may include any of the aforementioned client device types. The cloud computing system can communicate with a datastore that may be co-located with the cloud computing system. Of course not all device implementations can be illustrated and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions to provide functionality. Computer-readable instructions and/or data can be stored on storage, such as storage/memory and or the datastore.

The storage/memory can be internal or external to the device. The storage can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose processor and storage/memory. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor” as used herein can also refer to central processing units (CPUs), graphical processing units (CPUs), controllers, microcontrollers, processor cores, or other types of processing devices suitable for implementation both in conventional computing architectures as well as SOC designs.

Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, the meeting evaluation module and/or interface module can be installed as hardware, firmware, or software during manufacture of the device or by an intermediary that prepares the device for sale to the end user. In other instances, the end user may install these modules later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods described herein can be performed on a single computing device and/or distributed across multiple computing devices that communicate over network(s) 250. Without limitation, network(s) 250 can include one or more local area networks (LANs), wide area networks (WANs), the Internet, and the like.

### Further Examples

The various examples discussed herein can include a first method example performed by at least one hardware processor. The first method example can include obtaining previous meeting attributes of previous meetings that were attended by a user or to which the user was invited, obtaining implicit feedback for the previous meetings from a device of the user, and training a predictive algorithm to evaluate future meetings for the user using the previous meeting attributes and the implicit feedback about the previous meetings. In a second method example, the first method example can further include obtaining other previous meeting attributes of other previous meetings attended by another user or to which the another user was invited, obtaining other implicit feedback about the other previous meetings from another device of the another user, and training the predictive algorithm to evaluate other future meetings for the another user using the other previous meeting attributes and the other implicit feedback. In a third method example, the second method example can further include obtaining explicit feedback from the device of the user about the previous meetings and other explicit feedback from the another device of the another user, and training the predictive algorithm for the user using the explicit feedback and for the another user using the other explicit feedback. In a fourth method example, the explicit feedback of the third method example includes ratings of the previous meetings and the other explicit feedback comprises other ratings of the other previous meetings. In a fifth method example, the training the predictive algorithm of the first through fourth method examples includes training a mapping algorithm to evaluate individual previous meetings using the implicit feedback. In a sixth method example, the previous meetings of the first through fifth method examples include physical meetings and virtual meetings. In a seventh method example, the first through sixth method examples also include obtaining future meeting attributes for an individual future meeting and evaluating the future meeting attributes of the individual future meeting using the trained predictive algorithm to obtain an evaluation of the individual future meeting. In an eighth method example, the previous meeting attributes of the first through seventh method examples identify meeting participants. In a ninth method example, the previous meeting attributes of the first through eighth method examples identify a relationship between the user and a meeting organizer determined using an organizational hierarchy. In a tenth method example, the previous meeting attributes of the first through ninth method examples identify meeting locations. In some further method examples, some or all of the first through tenth method examples are performed by a meeting evaluation module executing remotely from a client device on a server, and alternatively by a meeting evaluation module executing on the client device.

The various examples discussed herein can include an additional first method example performed by at least one hardware processor. The additional first method example can include obtaining explicit evaluations of certain previous meetings attended by a user, obtaining implicit feedback about the certain previous meetings from a device of the user, and training a mapping algorithm to map the implicit feedback to the explicit evaluations. In a second additional method example, the explicit evaluations of the additional first method example include usefulness ratings of the certain previous meetings. In a third additional method example, the implicit feedback of the first additional and second additional method examples reflects application usage by the user during the certain previous meetings. In a fourth additional method example, the implicit feedback of the first through third additional method examples reflects whether the user was physically present during the certain previous meetings. In a fifth additional method example, the implicit feedback of the first through fourth additional method examples reflects whether the user spoke at the certain previous meetings. In a sixth additional method example, the implicit feedback of the first through fifth additional method examples reflects whether the user communicated via telephone or email during the certain previous meetings. In a seventh additional method example, the first through sixth additional method examples further include obtaining other implicit feedback from the user about other previous meetings attended by the user, and applying the trained mapping algorithm to the other implicit feedback to obtain other evaluations of the other previous meetings. In some further method examples, some or all of the first through seventh additional method examples are performed by a meeting evaluation module executing remotely from a client device on a server, and alternatively by a meeting evaluation module executing on the client device.

The various examples discussed herein can also include an example computing system that includes one or more hardware processing units and one or more computer-readable storage devices storing computer-executable instructions which, when executed by the one or more hardware processing units, cause the one or more hardware processing units to monitor usage of the computing device during certain meetings to obtain implicit feedback about the certain meetings, provide the implicit feedback to a meeting evaluation module having a predictive algorithm trained to evaluate future meetings, and obtain an evaluation of an individual future meeting from the meeting evaluation module. In a second example computing system, the meeting evaluation module of the first example computing system is executed on another computing device located remotely from the computing system and the computer-executable instructions cause the one or more hardware processing units to provide the implicit feedback to the meeting evaluation module by sending the implicit feedback over a network to the another computing device that executes the meeting evaluation module. In a third example computing system, the computer-executable instructions of the first or second example computing system cause the one or more hardware processing units to display a graphical user interface that conveys the evaluation of the individual future meeting.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method performed by at least one hardware processor, the method comprising:
obtaining previous meeting attributes of previous meetings that were attended by a user or to which the user was invited;
obtaining implicit feedback for the previous meetings from a device of the user; and
training a predictive algorithm to evaluate future meetings for the user using the previous meeting attributes and the implicit feedback about the previous meetings.

2. The method of claim 1, further comprising:
obtaining other previous meeting attributes of other previous meetings attended by another user or to which the another user was invited;
obtaining other implicit feedback about the other previous meetings from another device of the another user; and
training the predictive algorithm to evaluate other future meetings for the another user using the other previous meeting attributes and the other implicit feedback.

3. The method of claim 2, further comprising:
obtaining explicit feedback from the device of the user about the previous meetings and other explicit feedback from the another device of the another user; and
training the predictive algorithm for the user using the explicit feedback and for the another user using the other explicit feedback.

4. The method of claim 3, wherein the explicit feedback comprises ratings of the previous meetings and the other explicit feedback comprises other ratings of the other previous meetings.

5. The method of claim 1, wherein training the predictive algorithm comprises training a mapping algorithm to evaluate individual previous meetings using the implicit feedback.

6. The method of claim 1, wherein the previous meetings comprise both physical meetings and virtual meetings.

7. The method of claim 1, further comprising:
obtaining future meeting attributes for an individual future meeting; and
evaluating the future meeting attributes of the individual future meeting using the trained predictive algorithm to obtain an evaluation of the individual future meeting.

8. The method of claim 1, wherein the previous meeting attributes identify meeting participants.

9. The method of claim 1, wherein the previous meeting attributes identify a relationship between the user and a meeting organizer determined using an organizational hierarchy.

10. The method of claim 1, wherein the previous meeting attributes identify meeting locations.

11. A method performed by at least one hardware processor, the method comprising:
obtaining explicit evaluations of certain previous meetings attended by a user;
obtaining implicit feedback about the certain previous meetings from a device of the user; and
training a mapping algorithm to map the implicit feedback to the explicit evaluations.

12. The method of claim 11, wherein the explicit evaluations comprise usefulness ratings of the certain previous meetings.

13. The method of claim 11, wherein the implicit feedback reflects application usage by the user during the certain previous meetings.

14. The method of claim 11, wherein the implicit feedback reflects whether the user was physically present during the certain previous meetings.

15. The method of claim 11, wherein the implicit feedback reflects whether the user spoke at the certain previous meetings.

16. The method of claim 11, wherein the implicit feedback reflects whether the user communicated via telephone or email during the certain previous meetings.

17. The method of claim 11, further comprising:
obtaining other implicit feedback from the user about other previous meetings attended by the user; and
applying the trained mapping algorithm to the other implicit feedback to obtain other evaluations of the other previous meetings.

18. A computing system comprising:
one or more hardware processing units; and
one or more computer-readable storage devices storing computer-executable instructions which, when executed by the one or more hardware processing units, cause the one or more processing units to:
monitor usage of the computing device during certain meetings to obtain implicit feedback about the certain meetings;
provide the implicit feedback to a meeting evaluation module having a predictive algorithm trained to evaluate future meetings; and
obtain an evaluation of an individual future meeting from the meeting evaluation module.

19. The computing system of claim 18, wherein the meeting evaluation module is executed on another computing device located remotely from the computing system and the computer-executable instructions cause the one or more hardware processing units to:
provide the implicit feedback to the meeting evaluation module by sending the implicit feedback over a network to the another computing device that executes the meeting evaluation module.

20. The computing system of claim 18, wherein the computer-executable instructions cause the one or more hardware processing units to:
display a graphical user interface that conveys the evaluation of the individual future meeting.
